(19) United States
(12) Patent Application Publication
(10) Pub. No.: US 2018/0213109 A1
(43) Pub. Date: Jul. 26, 2018

(54) FACSIMILE APPARATUS

(71) Applicant: KYOCERA Document Solutions Inc., Osaka (JP)

(72) Inventor: Masahiro Nishiyama, Osaka (JP)

(73) Assignee: Kyocera Document Solutions

(21) Appl. No.: 15/876,971

(22) Filed: Jan. 22, 2018

(30) Foreign Application Priority Data
Jan. 23, 2017 (JP) 2017-009870

(51) Int. Cl. H04N 1/21; H04N 1/32

(52) U.S. Cl. CPC H04N 1/2179; H04N 1/32101; H04N 1/32085

(57) ABSTRACT

A facsimile apparatus includes a facsimile control unit, a subbox generating unit, and a facsimile managing unit. The facsimile control unit is configured to obtain facsimile image data of a received facsimile. The subbox generating unit is configured to (a) extract receiver information or sender information from the facsimile image data, (b) determine a company name, one or plural belonging group names and a name of a receiver or a sender that are continuously included in the receiver information or the sender information, and (c) hierarchically generate subboxes on the basis of the determined company name, the determined one or plural belonging group names and the determined name. The facsimile managing unit is configured to store the facsimile image data into a subbox of which a name is the same as the determined name in a lowest layer among the subboxes hierarchically generated.

### CROSS-REFERENCE TO RELATED APPLICATIONS

This application relates to and claims priority rights from Japanese Patent Application No. 2017-009870, filed on Jan. 23, 2017, the entire disclosures of which are hereby incorporated by reference herein.

### BACKGROUND

### 1. Field of the Present Disclosure

The present disclosure relates to a facsimile apparatus.

### 2. Description of the Related Art

A facsimile apparatus (hereinafter called a first facsimile apparatus) performs an OCR (Optical Character Recognition) process for a received facsimile information and thereby identifies a receiver name of the facsimile, and stores the facsimile information into a mailbox of which the name is the same as or most similar to the identified receiver name.

Another facsimile apparatus (hereinafter called a second facsimile apparatus) stores facsimile image information into a post-office box (F code box) specified by an F code if the F code is attached as sub address information for confidential delivery to the facsimile image information.

However, in the first facsimile apparatus, in a case that the facsimile information is stored in a mailbox of which the name is the same as the identified receiver name, if there are a large number of users and thereby the number of mailboxes may be very large corresponding to the users, then it is difficult for a user to find his/her own mailbox in a mailbox list. In addition, when a user selects his/her own mailbox, the user easily sees a mailbox of another user who belongs to another group, and it is not favorable for confidentiality.

Further, in the first facsimile apparatus, in a case that the facsimile information is stored in a mailbox of which the name is most similar to the identified receiver name, plural pieces of facsimile information directed to plural users may be mingled in one mailbox, and it is not favorable for confidentiality.

In the second facsimile apparatus, confidentiality is assured but it is required to associate setting values of F codes with F code boxes on the receiver side in advance, and therefore, such setting operations for the F codes are troublesome. In addition, if such F code is not set in advance, confidentiality is not assured.

### SUMMARY

A facsimile apparatus according to an aspect of the present disclosure includes a facsimile control unit, a subbox generating unit, and a facsimile managing unit. The facsimile control unit is configured to obtain facsimile image data of a received facsimile. The subbox generating unit is configured to (a) extract receiver information or sender information from the facsimile image data, (b) determine a company name, one or plural belonging group names and a name of a receiver or a sender that are continuously included in the receiver information or the sender information, and (c) hierarchically generate subboxes on the basis of the determined company name, the determined one or plural belonging group names and the determined name. The facsimile managing unit is configured to store the facsimile image data into a subbox of which a name is the same as the determined name in a lowest layer among the subboxes hierarchically generated.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of a facsimile apparatus according to an embodiment of the present disclosure;

FIG. 2 shows a diagram that indicates an example of subbox generation rule data 41 shown in FIG. 1;

FIG. 3 shows a diagram that indicates an example of a hierarchical structure of subboxes generated by a subbox generating unit 32 shown in FIG. 1; and

FIG. 4 shows a flowchart that explains a behavior of the facsimile apparatus 1 shown in FIG. 1.

### DETAILED DESCRIPTION

Hereinafter, an embodiment according to an aspect of the present disclosure will be explained with reference to drawings.

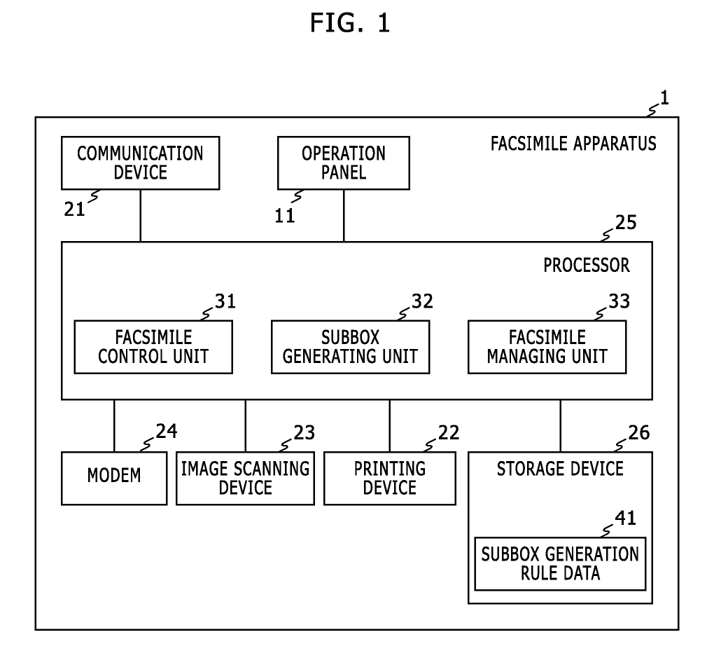

FIG. 1 shows a block diagram that indicates a configuration of a facsimile apparatus according to an embodiment of the present disclosure. The facsimile apparatus 1 shown in FIG. 1 is, for example, a multi function peripheral that has a facsimile function (ITU-TT.36 Standard), an Internet facsimile function (ITU-TT.37 Standard), and an IP facsimile function (ITU-TT.38 Standard).

As shown in FIG. 1, this facsimile apparatus 1 includes an operation panel 11, a communication device 21, a printing device 22, an image scanning device 23, a modem 24, a processor 25, and a storage device 26.

The operation panel 11 includes a display device such as a liquid crystal display and an input device such as a touch panel, and displays an operation screen for a user and detects a user operation.

Further, the communication device 21 is a device that is connected to a computer network and performs data communication with another facsimile apparatus directly or indirectly through the computer network.

Furthermore, the printing device 22 is an internal device that prints a document image on a printing paper sheet, for example, in an electrophotographic manner. The printing device 22 performs printing on the basis of output image data generated by performing predetermined image processing such as rasterizing, color conversion or a screen process for an original image data.

Furthermore, the image scanning device 23 is an internal device that optically scans a document image from a document, and generates image data of the document image.

Furthermore, the modem 24 is a device that performs communication with another facsimile apparatus through a telephone line.

Hereinafter, image data obtained on the basis of facsimile data received with Internet facsimile, IP facsimile, facsimile or the like is called as facsimile image data.

Furthermore, the processor 25 is a computer that includes a CPU (Central Processing Unit), a ROM (Read Only Memory), a RAM (Random Access Memory) and the like, loads a program from the ROM and the like to the RAM, and executes the program with the CPU to act as various processing units. The processor 25 acts as a facsimile control unit 31, a subbox generating unit 32, and a facsimile managing unit 33.

The storage device 26 is a non-volatile storage device such as a flash memory, and stores facsimile image data into any mailbox in a hierarchical structure.

Further, the storage device 26 stores subbox generation rule data 41.

The subbox generation rule data 41 is individually set to each receiver or each sender, and is data that indicates generation necessity of each of the subboxes corresponding to the company name, the one or plural belonging group names and the name.

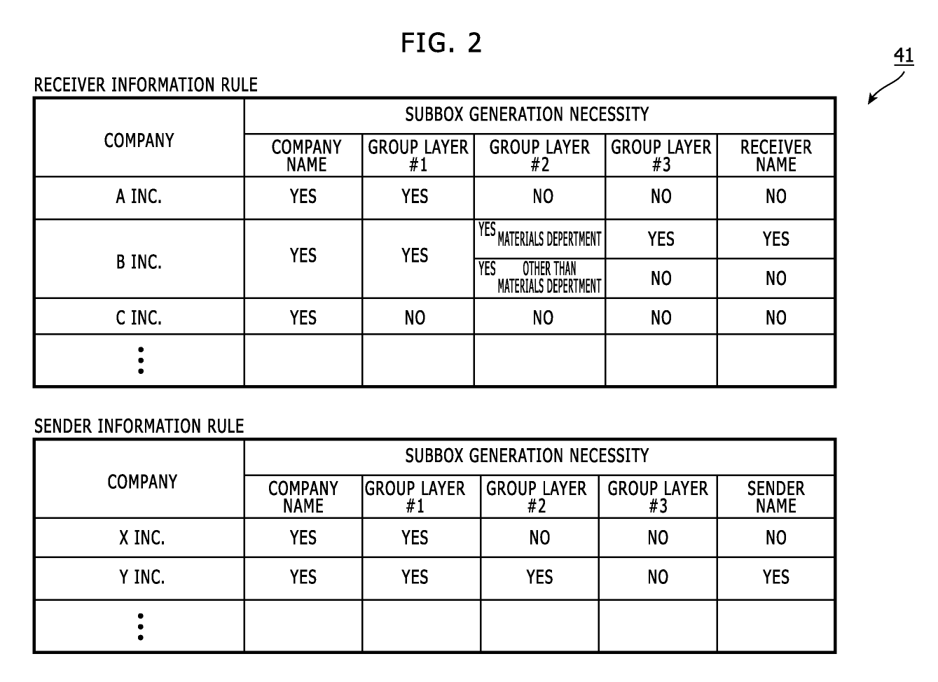

FIG. 2 shows a diagram that indicates an example of subbox generation rule data 41 shown in FIG. 1. FIG. 2 indicates the subbox generation rule data 41 in a case that the facsimile apparatus 1 is shared by plural companies (A Inc., B Inc. and C Inc) such as plural group companies.

The subbox generation rule data 41 includes a receiver information rule to be applied to receiver information and a sender information rule to be applied to sender information.

For example, according to a receiver information rule for “A Inc.” as a receiver, a subbox is generated so as to have its name as same as the second phrase of receiver information, i.e. “company name”; as a subbox in a lower layer than the “company name” subbox, a subbox is generated so as to have its name as same as the next phrase of the receiver information, i.e. “group #1”, and no subboxes in a lower layer are generated corresponding to subsequent phrases of the receiver information (“group #2”, “group #3” and “sender”).

The subbox generation rule data 41 may include a default subbox generation rule. In such a case, if a specific company name for which a subbox generation rule is set individually is not detected in the receiver information or the sender information, then the default subbox generation rule is used for the receiver information or the sender information.

The facsimile control unit 31 obtains facsimile image data of a received facsimile from the communication device 21 or the modem 24.

The subbox generating unit 32 (a) extracts receiver information or sender information from the obtained facsimile image data using an OCR technique, (b) determines a company name, one or plural belonging group names and a name of a receiver or a sender that are continuously included in the receiver information or the sender information, and (c) hierarchically generates subboxes on the basis of the determined company name, the determined one or plural belonging group names and the determined name.

In this embodiment, the subbox generating unit 32 selects any of a receiver information mode and a sender information mode in accordance with priority data as setting data.

When the receiver information mode is selected, using a receiver information rule included in the subbox generation ruled data 41, (a) if the receiver information is successfully extracted from the facsimile image data, (even if the sender information is successfully extracted) then the subbox generating unit 32 (a) determines a company name, one or plural belonging group names and a name of a receiver that are continuously included in the receiver information, and hierarchically generates subboxes on the basis of the determined company name, the determined one or plural belonging group names and the determined name; and (b) if the receiver information is not successfully extracted, then the subbox generating unit 32 determines a company name, one or plural belonging group names and a name of a sender that are continuously included in the sender information, and hierarchically generates subboxes on the basis of the determined company name, the determined one or plural belonging group names and the determined name.

When the sender information mode is selected, using a sender information rule included in the subbox generation ruled data 41, (a) if the sender information is successfully extracted, then the subbox generating unit 32 determines a company name, one or plural belonging group names and a name of a sender that are continuously included in the sender information, and hierarchically generates subboxes on the basis of the determined company name, the determined one or plural belonging group names and the determined name, and (b) if the sender information is not successfully extracted, then the subbox generating unit 32 determines a company name, one or plural belonging group names and a name of a sender that are continuously included in the receiver information, and hierarchically generates subboxes on the basis of the determined company name, the determined one or plural belonging group names and the determined name.

For example, a phrase subsequent to a predetermined phrase (for example, “To”) is extracted as the receiver information. In addition, for example, a phrase subsequent to a predetermined phrase (for example, “From”) is extracted as the sender information.

It should be noted that if a subbox to be generated already exists, the subbox generating unit 32 omits the generation of the subbox to be generated.

In this embodiment, the subbox generating unit 32 hierarchically generates the subboxes in accordance with the subbox generation rule data 41.

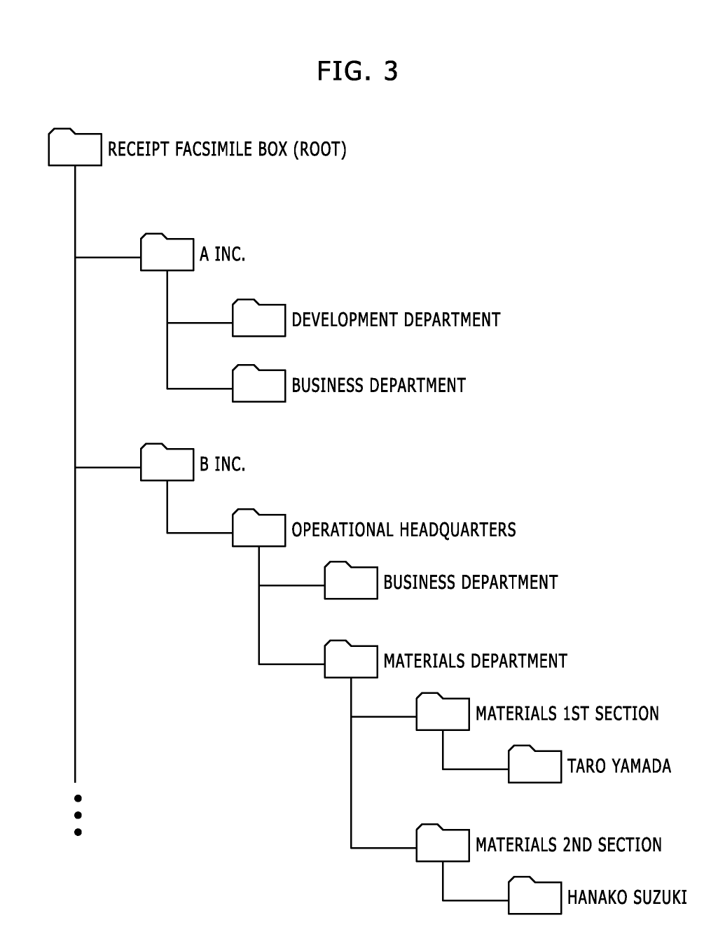

FIG. 3 shows a diagram that indicates an example of a hierarchical structure of subboxes generated by the subbox generating unit 32 shown in FIG. 1.

For example, if the extracted receiver information is “Taro Yamada B Inc. Operational headquarters Materials department Material 1st section”, then “B Inc.” is detected and therefore a receiver information rule for “B Inc.” is selected in the subbox generation rule data 41.

Here, as “company name” in the subbox generation rule data 41 shown in FIG. 2, the second phrase “B Inc.” of the receiver information is determined; as “group #1”, the next phrase “Operational headquarters” is determined; as “group #2”, the subsequent phrase “Materials department” is determined; as “group #3”, the subsequent phrase “Material 1st section” is determined; and as “receiver name”, the first phrase “Taro Yamada” is determined.

Subsequently, as shown in FIG. 3, a subbox “B Inc.” is firstly generated; a subbox “Operational headquarters” is generated as a subbox in a lower layer than the subbox “B Inc.”; a subbox “Materials department” is generated as a subbox in a lower layer than the subbox “Operational headquarters”; a subbox “Material 1st section” is generated as a subbox in a lower layer than the subbox “Materials department”; and a subbox “Taro Yamada” is generated as a subbox in a lower layer than the subbox “Material 1st section”.

The facsimile managing unit 33 stores the obtained facsimile image data into the subbox in the lowest layer that has its name as same as a name of a receiver or a sender among the subboxes generated hierarchically. In the aforementioned example, the obtained facsimile image data is stored into the subbox “Taro Yamada”.

Further, the facsimile managing unit 33 outputs the facsimile image data stored in the subbox if an output request is received. At that time, for example, the facsimile managing unit 33 performs printing of a facsimile image based on the facsimile image data using the printing device 22, displays the facsimile image on the operation panel 11 or transmits the facsimile image data to a predetermined address using the communication device 21. The output request is inputted from the operation panel 11 on the basis of a user operation or received from an unshown host device.

The subbox generating unit 32 can set a password to the subbox. This password may be specified by a user or may be a default password. The facsimile managing unit 33 (a) obtains a password and an output request to specify the facsimile image data, and (b1) outputs the facsimile image data specified by the output request if the obtained password is the same as the password set to the subbox that includes the facsimile image data specified by the output request and (b2) does not output the facsimile image data specified by the output request if the obtained password is not the same as the password set to the subbox that includes the facsimile image data specified by the output request.

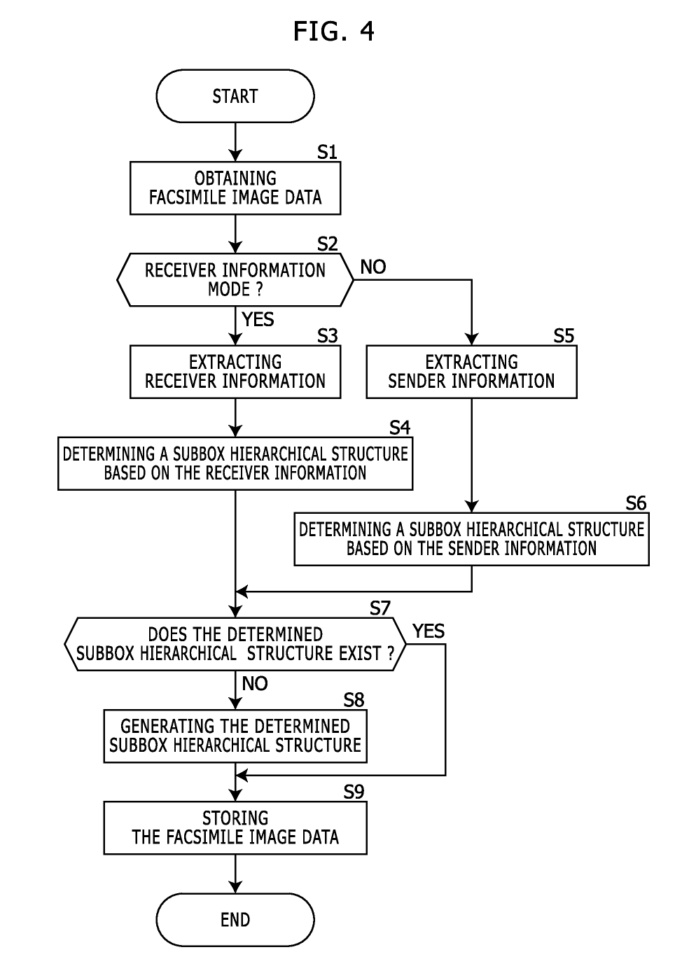

The following part explains a behavior of the facsimile apparatus 1 according to this embodiment. FIG. 4 shows a flowchart that explains a behavior of the facsimile apparatus 1 shown in FIG. 1.

When the communication device 21 or the modem 24 receives a facsimile, the facsimile control unit 31 obtains facsimile image data from the communication device 21 or the modem 24 (in Step S1).

When obtaining the facsimile image data, the subbox generating unit 32 firstly determines whether the receiver information mode is specified by the priority data or not (in Step S2).

If the receiver information mode is specified by the priority data, then in the receiver information mode, the subbox generating unit 32 extracts receiver information from the facsimile information data (in Step S3), and for storing this facsimile image data, determines a hierarchical structure corresponding to the extracted receiver information in accordance with a receiver information rule included in the subbox generation rule data 41 (in Step S4).

If receiver information is not extracted from the facsimile image data in Step S3, then an action mode of the subbox generating unit 32 is changed from the receiver information mode to the sender information mode, and the processes in Steps S5 and S6 are performed.

Contrarily, if the receiver information mode is not specified by the priority data (i.e. if the sender information mode is specified by the priority data), then in the sender information mode, the subbox generating unit 32 extracts sender information from the facsimile image data (in Step S5), and for storing this facsimile image data, determines a hierarchical structure corresponding to the extracted sender information in accordance with a sender information rule included in the subbox generation rule data 41 (in Step S6).

If sender information is not extracted from the facsimile image data in Step S5, then an action mode of the subbox generating unit 32 is changed from the sender information mode to the receiver information mode, and the processes in Steps S3 and S4 are performed.

Subsequently, the subbox generating unit 32 determines whether the determined subbox hierarchical structure already exists in the storage device 26 or not (in Step S7), and if the determined subbox hierarchical structure does not exist, the subbox generating unit 32 generates an insufficient subbox and thereby completes the determined subbox hierarchical structure (in Step S8).

Upon obtaining the subbox hierarchical structure corresponding to the facsimile image data as mentioned, the facsimile managing unit 33 stores the facsimile image data into a subbox in the lowest layer in the subbox hierarchical structure (in Step S9).

Afterward, a user operates an unshown host device or the operation panel 11 and thereby specifies a subbox and inputs a facsimile reading request to the facsimile apparatus 1, and reads a list of facsimile image data in this subbox, selects a desired facsimile image data in the list, and inputs to the facsimile apparatus 1 an output request that specifies the selected facsimile image data.

Upon receiving the output request, the facsimile managing unit 33 outputs the facsimile image data specified by the output request. In this process, if a password has been set to a subbox that includes this facsimile image data, then as mentioned, after successful password authentication, the facsimile image data is outputted.

In the aforementioned embodiment, the facsimile control unit 31 obtains facsimile image data of a received facsimile. The subbox generating unit 32 (a) extracts receiver information or sender information from the facsimile image data, (b) determines a company name, one or plural belonging group names and a name of a receiver or a sender that are continuously included in the receiver information or the sender information, and (c) hierarchically generates subboxes on the basis of the determined company name, the determined one or plural belonging group names and the determined name. The facsimile managing unit 33 stores the facsimile image data into the subbox in the lowest layer that has its name as same as a name of a receiver or a sender among the subboxes generated hierarchically.

Consequently, facsimile image data of a received facsimile is stored into a subbox in the lowest layer in a subbox hierarchical structure corresponding to a company name, a belonging group name, a receiver or sender and the like, and therefore, when a user reads facsimile image data in a user's own subbox (as a receiver) or facsimile image data in a subbox of a sender of a facsimile directed to this user, the user does not easily sees a mailbox without any relations to this user, and the received facsimile is stored with keeping confidentiality, without using a specific protocol such as F code.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, if the obtained password is not the same as the password set to the subbox that includes the facsimile image data specified by the output request, then the facsimile managing unit 33 (a) may output the facsimile image data specified by the output request if the obtained password is the same as the password set to a subbox in a layer higher than the subbox that includes the facsimile image data specified by the output request and (b) may not output the facsimile image data specified by the output request if the obtained password is not the same as the password set to a subbox in any layer higher than the subbox that includes the facsimile image data specified by the output request.

Further, in the aforementioned embodiment, if the obtained password is not the same as the password set to the subbox that includes the facsimile image data specified by the output request, then the facsimile managing unit 33 (a) may output the facsimile image data specified by the output request if the obtained password is the same as the password set to a subbox in a layer lower than the subbox that includes the facsimile image data specified by the output request and (b) may not output the facsimile image data specified by the output request if the obtained password is not the same as the password set to a subbox in any layer lower than the subbox that includes the facsimile image data specified by the output request.

What is claimed is:

1. A facsimile apparatus, comprising:
a facsimile control unit configured to obtain facsimile image data of a received facsimile;
a subbox generating unit configured to (a) extract receiver information or sender information from the facsimile image data, (b) determine a company name, one or plural belonging group names and a name of a receiver or a sender that are continuously included in the receiver information or the sender information, and (c) hierarchically generate subboxes on the basis of the determined company name, the determined one or plural belonging group names and the determined name; and
a facsimile managing unit configured to store the facsimile image data into a subbox of which a name is the same as the determined name in a lowest layer among the subboxes hierarchically generated.

2. The facsimile apparatus according to claim 1, wherein the subbox generating unit hierarchically generates the subboxes in accordance with subbox generation rule data; and
the subbox generation rule data is set to each receiver or each sender, and is data that indicates generation necessity of each of the subboxes corresponding to the company name, the one or plural belonging group names and the name.

3. The facsimile apparatus according to claim 1, wherein the subbox generating unit sets a password to the subbox; and
the facsimile managing unit (a) obtains a password and an output request to specify the facsimile image data, and (b1) outputs the facsimile image data specified by the output request if the obtained password is the same as the password set to the subbox that includes the facsimile image data specified by the output request and (b2) does not output the facsimile image data specified by the output request if the obtained password is not the same as the password set to the subbox that includes the facsimile image data specified by the output request.

4. The facsimile apparatus according to claim 3, wherein if the obtained password is not the same as the password set to the subbox that includes the facsimile image data specified by the output request, then the facsimile managing unit (b21) outputs the facsimile image data specified by the output request if the obtained password is the same as the password set to a subbox in a layer higher than the subbox that includes the facsimile image data specified by the output request and (b22) does not output the facsimile image data specified by the output request if the obtained password is not the same as the password set to a subbox in any layer higher than the subbox that includes the facsimile image data specified by the output request.

5. The facsimile apparatus according to claim 3, wherein if the obtained password is not the same as the password set to the subbox that includes the facsimile image data specified by the output request, then the facsimile managing unit (b21) outputs the facsimile image data specified by the output request if the obtained password is the same as the password set to a subbox in a layer lower than the subbox that includes the facsimile image data specified by the output request and (b22) does not output the facsimile image data specified by the output request if the obtained password is not the same as the password set to a subbox in any layer lower than the subbox that includes the facsimile image data specified by the output request.

6. The facsimile apparatus according to claim 1, wherein the subbox generating unit (a) selects any of a receiver information mode and a sender information mode in accordance with priority data; (b1) when the receiver information mode is selected, (b11) determines a company name, one or plural belonging group names and a name of a receiver that are continuously included in the receiver information, and hierarchically generates subboxes on the basis of the determined company name, the determined one or plural belonging group names and the determined name if the receiver information is successfully extracted, and (b12) determines a company name, one or plural belonging group names and a name of a sender that are continuously included in the sender information, and hierarchically generates subboxes on the basis of the determined company name, the determined one or plural belonging group names and the determined name if the receiver information is not successfully extracted; and (b2) when the sender information mode is selected, (b21) determines a company name, one or plural belonging group names and a name of a sender that are continuously included in the sender information, and hierarchically generates subboxes on the basis of the determined company name, the determined one or plural belonging group names and the determined name if the sender information is successfully extracted, and (b22) determines a company name, one or plural belonging group names and a name of a sender that are continuously included in the receiver information, and hierarchically generates subboxes on the basis of the determined company name, the determined one or plural belonging group names and the determined name if the sender information is not successfully extracted.
